(19) United States
(12) Patent Application Publication
(10) Pub. No.: US 2023/0250779 A1
(43) Pub. Date: Aug. 10, 2023

(54) Method And Device For Diagnosing The Tank Ventilation System Purge Line Path Of A Combustion-Engine-Powered Motor Vehicle

(71) Applicant: Vitesco Technologies GmbH, Regensburg (DE)

(72) Inventors: Thomas Pichler, Hohenau (DE); Thomas Koenig, Wörth an der Donau (DE); Dirk Jürgensen, Grossmehring (DE)

(73) Assignee: Vitesco Technologies GmbH, Regensburg (DE)

(21) Appl. No.: 18/300,910

(22) Filed: Apr. 14, 2023

Related U.S. Application Data
(63) Continuation of application No. PCT/EP2021/071575, filed on Aug. 2, 2021.

(30) Foreign Application Priority Data
Oct. 15, 2020 (DE) 10 2020 127 215.4

(51) Int. Cl. F02M 25/08

(52) U.S. Cl. CPC F02M 25/0809; F02M 25/0836; F02M 25/089

(57) ABSTRACT

A method for diagnosing a purge line path of a tank ventilation system of a motor vehicle operated by an internal combustion engine is provided. The purge line path extends between a fuel vapor retention filter and an intake manifold of the motor vehicle, and includes a tank ventilation valve, a pressure sensor, a purge line path region arranged upstream of the pressure sensor, a purge line path region arranged downstream of the pressure sensor, a full load purge path arranged between the tank ventilation valve and the intake manifold, and a part load purge path arranged between the tank ventilation valve and the intake manifold. A plurality of part diagnoses are carried out temporally one after another for diagnosing the purge line path in the case of an active tank ventilation function, and pressure signals measured by the pressure sensor are evaluated within the context of the part diagnoses.

### CROSS-REFERENCE TO RELATED APPLICATIONS

This application claims the benefit of International Application PCT/EP2021/071575, filed Aug. 2, 2021, which claims priority to German Application 10 2020 127 215.4, filed Oct. 15, 2020. The disclosures of the above applications are incorporated herein by reference.

### TECHNICAL FIELD

The disclosure relates to a method and an apparatus for diagnosing the purge line path of the tank ventilation system of a motor vehicle operated by an internal combustion engine.

### BACKGROUND

In order to limit the emissions of pollutants, modern motor vehicles, which are operated by internal combustion engine, are equipped with tank ventilation systems. The purpose of these tank ventilation systems is to absorb and temporarily store fuel vapor that is formed in a fuel tank by way of evaporation, with the result that the fuel vapor cannot escape into the surroundings. A fuel vapor retention filter which is, for example, an activated carbon filter is provided in the tank ventilation system as store for the fuel vapor. This fuel vapor retention filter has only a limited storage capacity for fuel vapor. In order for it to be possible for the fuel vapor retention filter to be used over a long period of time, it has to be regenerated. To this end, a controllable tank ventilation valve is arranged in a purge line path between the fuel vapor retention filter and an intake manifold of the internal combustion engine. The tank ventilation valve is opened to carry out the regeneration, with the result that firstly the fuel vapors, which are absorbed in the fuel vapor retention filter, can escape into the intake manifold on account of the negative pressure in the latter and thus are fed to the intake air of the internal combustion engine and therefore to the combustion, and secondly the absorption capability of the fuel vapor retention filter for fuel vapor is re-established.

FIG. 1 shows one example for a known motor vehicle operated by an internal combustion engine and includes a tank ventilation system. The system shown in FIG. 1 includes, inter alia, the following parts: a fuel tank 22; an activated carbon filter 3, in which hydrocarbons that are outgassed from the fuel tank 22 are absorbed; a tank ventilation valve 6 actuated by an engine controller 23 by a pulse width modulated (PWM) signal, in order to regulate the gas flow from the activated carbon filter 3 via a full load purge path 14 or a part load purge path 15 to an intake manifold 24 of the internal combustion engine; a branch, provided downstream of the tank ventilation valve 6, of the purge line path with check valves 7 and 8, by way of which the gas flow is fed either via the part load purge path 15 to an introduction point downstream of a throttle valve 21 or via the full load path 14 to an introduction point upstream of the compressor of a turbocharger, to which, furthermore, a turbine 26 belongs; an intake manifold 24 which, starting from an air filter 20, extends via the compressor 25 and the throttle valve 21 as far as an engine block 18; a Venturi nozzle 9 which generates a necessary differential pressure across the full load purge path 14 in the case of boost pressures above ambient pressure level and unthrottled engine operation; a pressure sensor 4 connected to the full load purge path in order to realize a line diagnosis of the full load purge path; a tank leak diagnosis component 2 connected to an air filter 1 via a fresh air line 10 and to the activated carbon filter 3 via a fresh air line 11, is used to carry out a tank leak diagnosis, and is configured, for example, as an electric pump unit; an injection system which injects a fuel quantity determined by the engine controller 23 into the cylinders of an engine block 18; a lambda sensor 27 which is arranged in the exhaust gas channel 19 of the motor vehicle for determining the residual oxygen content in the exhaust gas; a tank filling level sensor 5; a tank ventilation line 12 which leads from the fuel tank 22 to the activated carbon filter 3; a purge line path region 13 which leads from the activated carbon filter 3 to the tank ventilation valve 6, and a pressure sensor 17 which is connected to the intake manifold 24 for measuring the intake manifold pressure.

The engine controller 23 is configured, inter alia: to determine a setpoint value for the purge flow from the activated carbon filter 3 to the intake manifold of the internal combustion engine for a current operating state; to determine an intake manifold pressure with the aid of the pressure sensor 17; to determine a PWM value for actuating the tank ventilation valve 6 from the pressure gradient between the ambient pressure and the pressure at the respective introduction point into the intake manifold from the predefined purge flow; to determine a fuel quantity to be injected for a current operating state of the engine; to determine a delay time of the gas flow which is fed into the combustion by way of the opening of the tank ventilation valve 6 for the two abovementioned introduction points of the tank ventilation means; and to calculate a value for a correction of the fuel quantity to be injected based on a hydrocarbon concentration, learned by a lambda regulated deviation, of the purge mass flow.

In accordance with existing country-specific legal regulations, it is necessary to ensure or to diagnose the functional capability of the purge air line path. There constantly has to be a sufficiently great mass throughput from the activated carbon filter 3 to the intake manifold 24 of the internal combustion engine, in order to keep the hydrocarbon emissions from the tank ventilation system as low as possible.

For this purpose, it is necessary to check the functional capability of the entire purge line path consisting of the part load purge path 15, the full load purge path 14 and the purge line path, in which the tank ventilation valve 6 is arranged. The full load purge path becomes active if the Venturi nozzle 9 used to generate a sufficient purge air pressure gradient generates a higher pressure difference to the surroundings at high engine loads than that pressure difference which exists between the branching point downstream of the throttle valve 21 and the surroundings. The full load purge path in the tank ventilation system has to be diagnosed in a manner which is dependent on the respective legal regulation when the ratio of the full load purge air quantity to the entire purge air quantity exceeds a defined threshold in a predefined homologation cycle.

The part load purge path 15 is diagnosed with an open check valve 8, by the tank ventilation valve 6 being energized with a defined actuation pattern and the resulting pressure profile determined using the pressure sensor 17 in the intake manifold 24 being assessed.

The diagnosis of the full load purge path 14 is carried out with the aid of the pressure sensor 4 which is connected to the full load purge path. Here, in the case of an activated full load purge path and an open check valve 7, the tank ventilation valve 6 is energized with a predefined actuating pattern and the resulting pressure profile is assessed.

The above-described sequence of the purge line diagnosis has disadvantages. For instance, each start attempt of the diagnosis interrupts further diagnosis functions, for example a lambda probe diagnosis or a catalytic converter diagnosis. Furthermore, each start attempt of the diagnosis interrupts the tank ventilation function, as a result of which the purge air quantity within a driving cycle can be reduced considerably. Furthermore, the diagnosis of the part and full load purge path requires highly stable or restricted internal combustion engine operating states, which leads overall to a high number of diagnosis starts and a high number of interruptions. Moreover, tank ventilation valve actuations with great opening strokes are required to obtain significant and evaluable pressure changes in the intake manifold 24 and in the full load purge path 14. On account of the impairment of the mixture formation under certain conditions, these can have a negative effect on the drivability and the exhaust gas emissions. Above a certain hydrocarbon concentration of the mass flow through the tank ventilation valve, the stated actuation pattern of the tank ventilation valve has to be suspended, in order to prevent undesired drivability and emissions influences, and the diagnosis cannot be activated in the respective current driving cycle, which leads overall to a reduced activation ratio of the diagnosis. Furthermore, in the case of the described sequence of the purge line diagnosis, a tank ventilation valve which is jammed in an open state cannot be distinguished from a closed purge line path.

Although attempts have already been made to meet the legislative requirements in relation to the activation ratio of the purge line diagnosis and in relation to the minimum purge air quantity through the tank ventilation valve by way of very high calibration and coordination efforts during the setting of the diagnosis function, and although, furthermore, attempts have already been made to decrease undesired drivability and emissions influences within the context of the application processes, these measures have up to now not led to the desired success.

### SUMMARY

The disclosure provides a method and apparatus for diagnosing a purge line path of a tank ventilation system of a motor vehicle operated by internal combustion engine. The diagnosis of the purge line path can take place with an active tank ventilation function, without separate actuation processes of the tank ventilation valve being necessary.

In some implementations, a diagnosis of the purge line path takes place with the use of four part diagnoses, within which a measurement of the pressure which is set takes place in each case at a pressure sensor arranged between the activated carbon filter and the tank ventilation valve. This makes a diagnosis of the purge line path with an active tank ventilation function possible, without separate actuation processes of the tank ventilation valve being necessary.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an example for a known motor vehicle operated by an internal combustion engine and including a tank ventilation system.

FIG. 2 shows an exemplary apparatus according to the disclosure for diagnosing the purge line path of a tank ventilation system of a motor vehicle driven by an internal combustion engine.

FIG. 3 shows a flow chart to illustrate the diagnosis sequence.

FIG. 4 shows a diagram to illustrate different ranges of the working range of the pulse width modulation.

FIG. 5 shows a diagram to illustrate different pressure profiles.

Like reference symbols in the various drawings indicate like elements.

### DETAILED DESCRIPTION

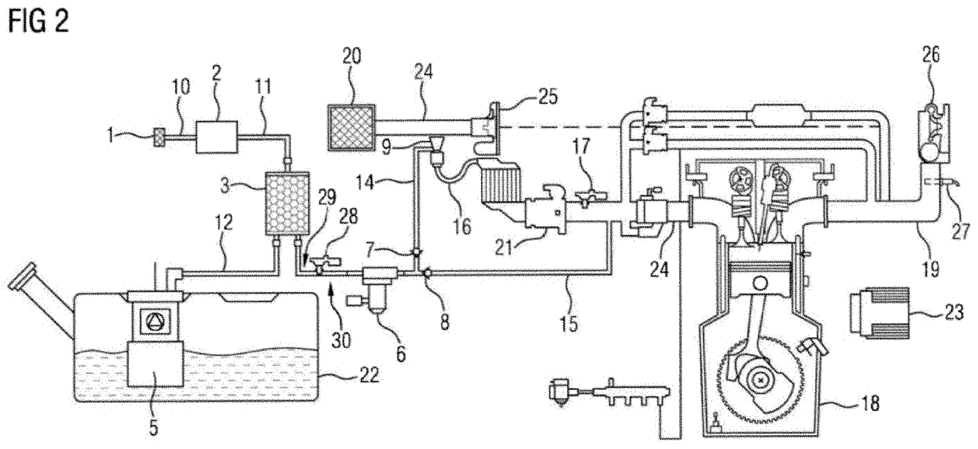

FIG. 2 shows one example for a motor vehicle that includes a tank ventilation system and that is operated by an internal combustion engine. A method according to the disclosure for diagnosing a purge line path of the tank ventilation system can be carried out.

The system which is shown in FIG. 2 includes, inter alia, the following constituent parts: a fuel tank 22; a fuel vapor retention filter which is realized as an activated carbon filter 3 and in which hydrocarbons outgassed from the fuel tank 22 are absorbed; an intake manifold 24 which, starting from an air filter 20, extends via a compressor 25 and a throttle valve 21 as far as the engine block 18; a tank ventilation valve 6 actuated by an engine controller 23 by way of a pulse width modulated (PWM) signal, in order to regulate the gas flow from the activated carbon filter 3 via a part load purge path 15 or a full load purge path 14 to the intake manifold 24, the full load purge path 14 leading via a Venturi nozzle 9 under high pressure line 16 to the intake manifold 24; a branch, provided downstream of the tank ventilation valve 6, of the purge line path with check valves 7 and 8, by way of which the gas flow is fed either via the part load purge path 15 to an introduction point downstream of the throttle valve 21 or via the full load purge path 14 to an introduction point upstream of the throttle valve 21; a Venturi nozzle 9 which generates a necessary differential pressure across the full load purge path 14 in the case of boost pressures above ambient pressure level and unthrottled engine operation; a pressure sensor 28 arranged between the activated carbon filter 3 and the tank ventilation valve 6; a purge line path region 29 arranged upstream of the pressure sensor 28 between the activated carbon filter 3 and the tank ventilation valve 6; a purge line path region 30 arranged downstream of the pressure sensor 28 between the activated carbon filter 3 and the tank ventilation valve 6; a tank leak diagnosis component 2, connected to an air filter 1 via a fresh air line 10 and to the activated carbon filter 3 via a fresh air line 11, is used to carry out a tank leak diagnosis, and configured, for example, as an electric pump unit; an injection system which injects a fuel quantity determined by the engine controller 23 into the cylinders of an engine block 18; a lambda sensor 27 arranged in the exhaust gas channel 19 of the motor vehicle for determining the residual oxygen content in the exhaust gas; a tank filling level sensor 5; a tank ventilation line 12 which leads from the fuel tank 22 to the activated carbon filter 3; and a pressure sensor 17 connected to the intake manifold 24 for measuring the intake manifold pressure.

The engine controller 23 is configured, inter alia, to determine a setpoint value for the purge flow from the activated carbon filter 3 to the intake manifold of the internal combustion engine for a current operating state, to determine an intake manifold pressure with the aid of the pressure sensor 17, to determine a PWM value for actuating the tank ventilation valve 6 from the pressure gradient between the ambient pressure and the pressure at the respective introduction point into the intake manifold from the predefined purge flow, to determine a fuel quantity to be injected for a current operating state of the engine, to determine a delay time of the gas flow which is fed in to the combustion by way of the opening of the tank ventilation valve 6 for the two abovementioned introduction points of the tank ventilation means, and to calculate a value for a correction of the fuel quantity to be injected on the basis of a hydrocarbon concentration, learned by means of a lambda regulator deviation, of the purge mass flow.

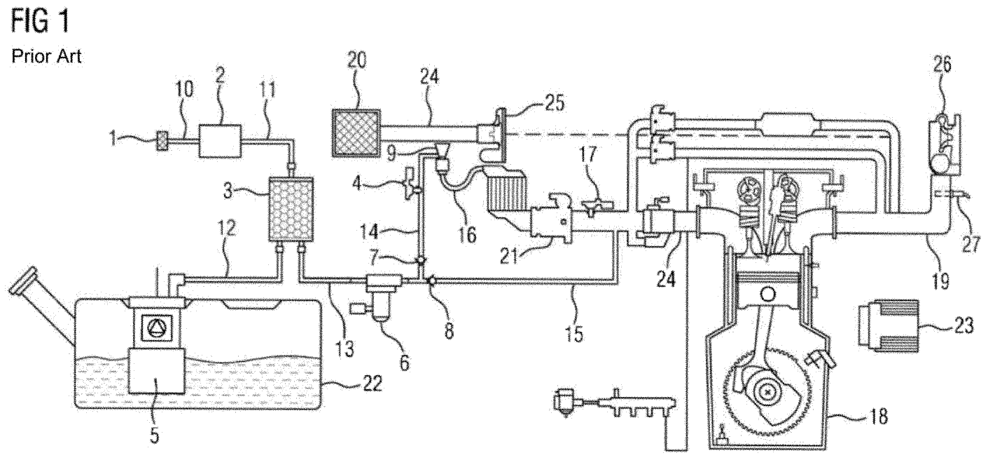

The apparatus shown in FIG. 2 differs from the apparatus shown in FIG. 1, for example, it does not include the pressure sensor 4 which is shown in FIG. 1 and is arranged in the purge line in the full load ventilation path 14. Instead, a pressure sensor 28 is arranged between the activated carbon filter 3 and the tank ventilation valve 6. Pressure measurements take place by this pressure sensor 28 within the context of the abovementioned part diagnoses, without requiring a separate actuation of the tank ventilation valve.

In the case of the part diagnosis A, a test is performed of the part load purge path 15 arranged downstream of the tank ventilation valve 6 including check valve, and a check is performed with regard to the presence of a tank ventilation valve 6 which is jammed in a closed state.

In the case of the part diagnosis B, a test is performed of the full load purge path 14 arranged downstream of the tank ventilation valve 6 including check valve, and a check is performed with regard to the presence of a tank ventilation valve 6 which is jammed in a closed state.

In the case of the part diagnosis C, a check is performed with regard to the presence of a tank ventilation valve 6 which is jammed in an open state.

In the case of the part diagnosis D, a check is performed to see whether the purge line path region 29 arranged upstream of the pressure sensor 28 is blocked.

A presence of leaks upstream of the tank ventilation valve 6 to the surroundings is localized with use of the tank leak diagnosis component 2.

Leaks of this type are not the subject matter of the disclosure and will therefore not be explained in detail.

The following Table 1 shows a breakdown which indicates the part diagnosis in which a respective part range of the complete purge line path is checked.

TABLE 1

| Component | Error indication | Part diagnosis |
|---|---|---|
| Purge line path region 29 | Blocked | D |
| upstream of the pressure | Leak | ** |
| sensor 28 | | |
| Full load purge path 14 | Blocked | B |
| | Leak | B |
| Part load purge path 15 | Blocked | A |
| | Leak | A |
| High pressure line 16 | Blocked | B |
| (driving jet line) | Leak | B |
| Purge line path region 30 | Blocked | A/B |
| downstream of the | Leak | A/B/** |
| pressure sensor 28 | | |
| Tank ventilation valve 6 | Jammed in an open state | C/** |
| | Jammed in a closed state | A/B |
| Check valve 7 | Blocked | B |
| | Leak | B |
| Check valve 8 | Blocked | A |
| | Leak | A |
| Venturi nozzle 9 | Blocked | B |
| | Leak | B |

** Leak check

In order for it to be possible for pinpointing to the defective components listed in the above Table 1 to be ensured, the diagnosis process sequence explained in the following text is carried out:

1. Diagnosis D:

Check for the presence of a blocked purge line path region 29 upstream of the pressure sensor 28 (step 1):

In order to check for the presence of a blocked purge line path region 29 upstream of the pressure sensor 28, a pressure measurement takes place by the pressure sensor 28 with an activated tank ventilation function and a tank ventilation valve switched to allow passage, a significant mass flow being set. After an adjustable mass flow integral is reached (in the case of a fault, evacuation of the line volume downstream of the blockage as far as the tank ventilation valve 6), the pressure measured by the pressure sensor 28 in the purge line path region 29 is compared with the respective pressures at the introduction point of the instantaneously activated purge path (full load purge path 14 or part load purge path 15). In the case of the pressure which is measured by the pressure sensor approximating the pressures at the respective introduction points, the presence of a blocked purge line path upstream of the pressure sensor 28 can be extrapolated.

A precondition for the start of this part diagnosis is sufficiently great pressure difference, which can be set via the diagnosis algorithm, between the ambient pressure and the pressure at the respective active introduction point, in order for it to be possible for significant negative pressures to be measured by means of the pressure sensor 28.

2. Diagnosis C:

Check for the presence of a tank ventilation valve 6 which is jammed in an open state (step 2):

A pressure measurement takes place by the pressure sensor 28 in order to check for the presence of a tank ventilation valve 6 which is jammed in an open state, the tank ventilation function not actuating the tank ventilation valve 6. If the tank ventilation valve 6 is closed for an adjustable time, the pressure signal which is measured by the pressure sensor 28 approximates the ambient pressure in the case of the nominal system, since the activated carbon filter 3 is connected directly to the ambient air. If a tank ventilation valve 6 which is jammed in an open state is present, negative pressure is formed based on the pressure difference between the ambient pressure and the respective active introduction point and the current actuation level of the tank ventilation valve. Here, an adjustable negative pressure threshold serves to determine the presence of a tank ventilation valve which is jammed in an open state. A precondition for the start of this diagnosis is a sufficiently great pressure difference, which can be set via the diagnosis algorithm, between the ambient pressure and the respective active introduction point, in order for it to be possible for significant negative pressures to be measured by means of the pressure sensor 28.

3. Diagnosis AM:

Check of the purge line path downstream of the tank ventilation valve (steps 3 and 4):

After checking of the purge line path upstream of the pressure sensor 28 for the presence of a blockage and after jamming of the tank ventilation valve 6 in its open position can be ruled out, it is ensured that a pressure equalization in the direction of ambient pressure will take place in the case of a non-actuated tank ventilation valve 6. This then makes it possible for the pressure signal which is measured by the pressure sensor 28 for the check of the purge line path downstream of the tank ventilation valve 6 to be compared in the case of a non-actuated tank ventilation valve 6 and in the case of an actuated tank ventilation valve 6. For this purpose, a start pressure is measured based on the pressure which is measured by the pressure sensor 28 in the case of a non-actuated tank ventilation valve 6. Furthermore, an adjustable time is predefined, during which the tank ventilation valve 6 is closed. During following states, in the case of which the tank ventilation function opens the tank ventilation valve 6, the pressure signal which is measured by the pressure sensor 28 is in turn compared with the previously measured start pressure after an adjustable opening time. On account of the static pressure, decreasing in the case of the nominal system, in the purge line path upstream of the tank ventilation valve 6, a minimum negative pressure has to be set at the pressure sensor 28 based on the differential pressures which prevail in each case at the active introduction points. Here, a pressure threshold which can be set via the diagnosis algorithm is also predefined. If this minimum negative pressure is not reached, the presence of a defective purge line path downstream of the tank ventilation valve 6 or the presence of a tank ventilation valve 6 which is jammed in a closed state is extrapolated. Whether a check of the part load purge path 15 or the full load purge path 14 is performed first of all in the case of this procedure is dependent on which engine conditions first of all occur in the current driving cycle.

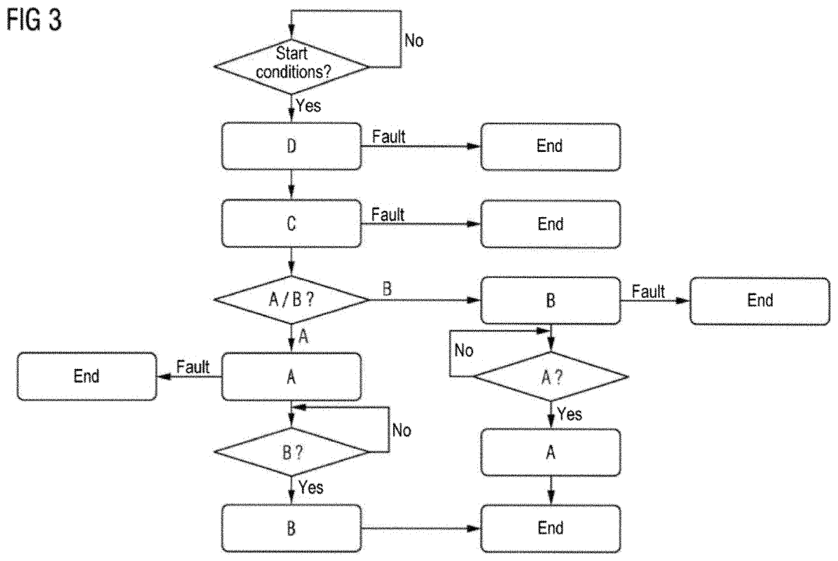

The above-described diagnosis process sequence will be illustrated in the following text based on FIG. 3.

This diagnosis process sequence begins with a query as to whether there are suitable start conditions for the purge line diagnosis or not. If there are these suitable start conditions, a switchover is carried out to the first part diagnosis D, in the case of which a check takes place as to whether there is a blockage in the purge line path region 29 upstream of the pressure sensor 28 or not.

If this check detects that there is a blockage of the purge line path region 29, there is a fault and the purge line diagnosis is ended. If this check detects, in contrast, that there is no blockage of the purge line path region 29, there is no fault and a transition takes place to the second part diagnosis C. A check is made in this part diagnosis C as to whether there is a tank ventilation valve 6 which is jammed in an open state or not.

If this check detects that there is a tank ventilation valve 6 which is jammed in an open state, there is a fault and the purge line diagnosis is ended. If this check detects, in contrast, that there is no tank ventilation valve 6 which is jammed in an open state, there is no fault and a transition takes place to a query, in which a check is made as to whether there are predefined activation conditions for a third part diagnosis A or a fourth part diagnosis B.

If this query detects that there are the activation conditions for the third part diagnosis A, a switchover is made to this third part diagnosis. In this third part diagnosis A, a check of the part load purge path 15 which is arranged downstream of the tank ventilation valve 6 and a check for the presence of a tank ventilation valve 6 which is jammed in a closed state take place.

If these checks detect that there is a defective part load purge path 15 and/or a tank ventilation valve 6 which is jammed in a closed state, there is a fault and the purge line diagnosis is ended. If these checks do not detect, in contrast, that there is a defective part load purge path and a tank ventilation valve which is jammed in a closed state, a transition takes place to a fourth part diagnosis B as soon as its activation conditions prevail.

In this fourth part diagnosis B, a check of the full load purge path 14 which is arranged downstream of the tank ventilation valve 6 and a check for the presence of a tank ventilation valve which is jammed in a closed state take place.

If these checks detect that there is a defective full load purge path 14 and/or a tank ventilation valve 6 which is jammed in a closed state, the presence of a fault is detected and the purge line diagnosis is ended. If these checks do not detect, in contrast, that there is a defective full load purge path and a tank ventilation valve which is jammed in a closed state, it is detected that the entire purge line path is fault-free. The method for diagnosing the purge line path is also ended in this case.

If, in contrast, it is detected in the case of the query as to whether there are predefined activation conditions for the third part diagnosis A or the fourth part diagnosis B that there are the activation conditions for the fourth part diagnosis B, a switchover is made to this fourth part diagnosis. In this fourth part diagnosis B, a check of the full load purge path 14 which is arranged downstream of the tank ventilation valve 6 and a check for the presence of a tank ventilation valve 6 which is jammed in a closed state take place.

If these checks detect that there is a defective full load purge path 14 and/or a tank ventilation valve 6 which is jammed in a closed state, there is a fault and the purge line diagnosis is ended. If these checks do not detect, in contrast, that there is a defective full load purge path and a tank ventilation valve which is jammed in a closed state, a transition takes place to the third part diagnosis A as soon as its activation conditions prevail.

In this third part diagnosis A, a check of the part load purge path 15 which is arranged downstream of the tank ventilation valve 6 and a check for the presence of a tank ventilation valve which is jammed in a closed state take place.

If these checks detect that there is a defective part load purge path 15 and/or a tank ventilation valve 6 which is jammed in a closed state, the presence of a fault is detected and the purge line diagnosis is ended. If these checks do not detect, in contrast, that there is a defective part load purge path and a tank ventilation valve which is jammed in a closed state, it is detected that the entire purge line path is fault-free. The method for diagnosing the purge line path is also ended in this case.

The above-described method has a plurality of advantages.

One advantage is that the diagnosis function is carried out without active intervention into the tank ventilation function by way of defined implementation logic. This leads to an increase in the tank ventilation purge rate during the driving cycle.

Furthermore, the performance sequence of the individual diagnosis steps ensures exact pinpointing of defective components or line sections in the purge line path. A blocked purge line path can therefore be distinguished from a tank ventilation valve 6 which is jammed in an open state.

A further advantage is that no interruption of competing diagnosis functions such as, for example, a lambda probe diagnosis and a catalytic converter diagnosis occurs.

Furthermore, undesired drivability and emissions influences which arise as a result of an active distribution of actuation profiles of the tank ventilation valve are prevented.

Furthermore, the purge line diagnosis can also be carried out in the case of the presence in the purge medium of a high concentration of the purge medium, since the pressure profiles directly upstream of the tank ventilation valve can be evaluated even in the case of low mass flows through the tank ventilation valve 6 and resulting small actuation duty cycles.

Furthermore, a tank ventilation valve 6 which is jammed in an open state can be distinguished by the described method from a closed purge line path or a closed tank ventilation valve 6.

A method and apparatus for diagnosing the purge line path of the tank ventilation system of a motor vehicle operated by internal combustion engine have been described above, in the case of which method and apparatus the diagnosis of the purge line path can take place in the case of an active tank ventilation function, without separate actuation operations of the tank ventilation valve being necessary.

In the case where the tank ventilation valve 6 is configured as a control valve, strong pressure fluctuations are generated upstream of the tank ventilation valve 6 in the actuating state at the purge line sensor system, that is to say the pressure sensor 28. This can have the consequence that the averaged pressure signal can be evaluated robustly only at high control ratios. In the case of low control ratios, an averaged line pressure is set which corresponds approximately to the ambient pressure, that is to say the value which the pressure assumes in the rest state of the tank ventilation valve 6. This makes a robust evaluation more difficult.

In order to ensure a robust evaluation, a specific evaluation strategy of the purge line pressure is proposed in accordance with one example of the disclosure. This makes it possible for the abovementioned passive purge line diagnosis to be carried out robustly even in the case of low control ratios of the tank ventilation valve 6 and a broadened operating range of the internal combustion engine in order to test the part load path and the full load path.

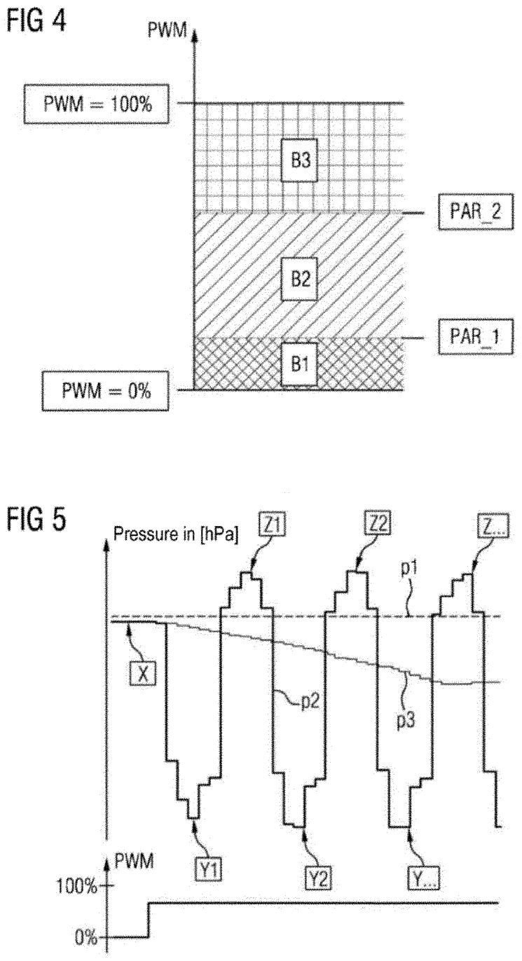

For this purpose, the actuating range shown in FIG. 4, that is to say the working range of the pulse width modulation (PWM) of the tank ventilation valve 6, is divided into three ranges B1, B2 and B3. Here, setting parameters PAR_1 and PAR_2 which can be calibrated and are stored in the engine controller in the form of characteristic diagrams form the range limits. The setting parameters are dependent, for example, on the engine load, the differential pressure across the respective active purge line, and the activation state of the purge line.

Range B1:

If the control ratio undershoots the threshold defined under PAR_1, no evaluation of the purge line pressure is performed. The actuating level of the tank ventilation valve 6 is too low in this range to obtain robustly evaluable pressure changes at the pressure sensor 28 after opening of the tank ventilation valve 6.

Range B2:

If the actuation of the tank ventilation valve 6 is situated in the range B2, which is an average actuating range of the tank ventilation valve 6 limited by the parameters PAR_1 and PAR_2, the pressure peaks which arise at the pressure sensor 4 are evaluated in accordance with the following pattern, in order to carry out the check of the part load path and the full load path:
First of all, it is ensured that the sampling rate of the pressure signal measured by the pressure sensor 28 and the computation grid of the executing diagnosis function follow the Nyquist-Shannon sampling theorem, that is to say it has to be ensured that there is an executing frequency of at least greater than or equal to twice the pressure signal frequency to be expected, generated by the clocking of the tank ventilation valve 6.
The entry point into the diagnosis sequence is a closed tank ventilation valve 6. Here, a start pressure is measured based on the pressure signal currently measured by the pressure sensor 28 in the case of a non-actuated tank ventilation valve 6. This pressure is labeled by “X” in FIG. 5.
After the tank ventilation valve actuation is activated in the range which lies between PAR_1 and PAR_2, the minimum (“Y”) and maximum (“Z”) pressures achieved at the pressure sensor 28 for an adjustable time are stored. At the beginning of the diagnosis, the “Y” and “Z” values are initialized for the start pressure “X”. This is illustrated in FIG. 5, in which the profile of the ambient pressure p1, the profile of the measured purge line pressure p2 with the measured minimum pressures Y1, Y2 and Y . . . and the measured maximum pressures Z1, Z2 and Z . . . and the profile of the averaged purge line pressure p3 are shown.
The criterion in respect of a good or bad check is formed finally by the difference between the determined minimum (“Y”) and maximum (“Z”) values. If the difference, measured during the adjustable time, between the minimum values and maximum values exceeds an adjustable parameter PAR_4, the presence of a functional tank ventilation path including tank ventilation valve 6 is extrapolated.
The following applies for a good check, for example: MAX (Z)−MIN (Y)>PAR_4.
The following applies for a bad check, for example: MAX (Z)−MIN (Y)≤PAR_4.
As an alternative to the above-described pressure difference formations with regard to a good or bad check, any desired combination of minimum and maximum pressures within the recorded pressure peaks can be used.
For example: MIN (Z)−MAX (Y)
in one example of the diagnosis, a defined number of good checks can be calibrated before a functional tank ventilation path is extrapolated.

Range B3:

The pressure signal measured by the pressure sensor 28 is compared for the check of the purge lines downstream of the tank ventilation valve 6 in the case of a non-actuated tank ventilation valve and in the case of an actuated tank ventilation valve. Here, the actuation level has to exceed at least PAR_2. To this end, a start pressure is measured based on the pressure signal at the pressure sensor 28 in the case of a non-actuated tank ventilation valve 6. Furthermore, an adjustable time is defined, for which the tank ventilation valve 6 is closed. In the case of following states, in which the tank ventilation function opens the tank ventilation valve 6, it being necessary for the actuation level to once again exceed the parameter PAR_2, the pressure value measured by the pressure sensor 28 is compared with the previously measured start pressure after an adjustable opening time. On account of the decreasing static pressure in the nominal system in the purge line upstream of the tank ventilation valve 6, a minimum negative pressure has to be set at the pressure sensor 28 based on the differential pressures prevailing in each case at the active introduction points. An adjustable pressure threshold is also predefined in this regard. If this minimum pressure is not reached, the presence of a defective purge line downstream of the tank ventilation valve 6 or a tank ventilation valve 6 which is jammed in a closed state can be extrapolated. Whether the check of the part load path or the full load path is performed first of all is dependent on which engine conditions first of all occur in the current driving cycle.

Once an activation of the diagnosis has taken place in the range B2 or B3, a closed tank ventilation valve is not required until the next entry into the range B1. This means that the switchover of the pressure evaluation functionality for the ranges B2 or B3 takes place without re-initialization of the diagnosis function (measurement of the start pressure) seamlessly via the setting parameter PAR_2.

The above-described procedure has the following advantages:
The execution of the described passive tank ventilation diagnosis function can be carried out both at low actuation levels of the tank ventilation valve and in a very broad operating range of the internal combustion engine on account of the splitting of the pressure evaluation ranges and the use of the associated pressure evaluation functionalities which are shown.
The diagnosis function is carried out without active intervention in the tank ventilation function in all physically evaluable actuation ranges, which results in an increase in the tank ventilation purge rate during the driving cycle.
Furthermore, no competing diagnosis functions, for example a lambda probe diagnosis and a catalytic converter diagnosis, are interrupted by the purge line diagnosis.
Furthermore, drivability and emissions influences as a result of active distribution of actuation profiles to the tank ventilation valve are eliminated.
The purge line diagnosis can be carried out even in the case of a high concentration of the purge medium, since the pressure profiles directly in front of the tank ventilation valve can already be evaluated in the case of low mass flows through the tank ventilation valve 6 and resulting small actuation duty cycles.
In the case of the described procedure, a tank ventilation valve 6 which is jammed in an open state can be distinguished from a closed purge line path or a closed tank ventilation valve 6.

A number of implementations have been described. Nevertheless, it will be understood that various modifications may be made without departing from the spirit and scope of the disclosure. Accordingly, other implementations are within the scope of the following claims.

What is claimed is:

1. A method for diagnosing a purge line path of a tank ventilation system of a motor vehicle operated by an internal combustion engine, the method comprising:
providing a purge line path extending between a fuel vapor retention filter and an intake manifold of the motor vehicle;
providing a tank ventilation valve along the purge line path;
providing a pressure sensor arranged between the fuel vapor retention filter and the tank ventilation valve;
providing a purge line path region arranged upstream of the pressure sensor;
providing a purge line path region arranged downstream of the pressure sensor;
providing a full load purge path arranged between the tank ventilation valve and the intake manifold;
providing a part load purge path arranged between the tank ventilation valve and the intake manifold;
executing a plurality of part diagnoses temporally one after another for the diagnosis of the purge line path, the part diagnoses are executed during an active tank ventilation function;
measuring, at pressure sensor arranged between the fuel vapor retention filter and the tank ventilation valve, pressure signals;
evaluating the measured pressure signals based on the part diagnoses.

2. The method of claim 1, wherein the part diagnoses executed during an active tank ventilation function, without separate actuation operations of the tank ventilation valve taking place.

3. The method of claim 1, further comprising:
in a first part diagnosis, checking a presence of a blockage in the purge line path region arranged upstream of the pressure sensor.

4. The method of claim 3, further comprising:
ending the diagnosis of the purge line path when a presence of a blockage in the purge line path region arranged upstream of the pressure sensor is detected.

5. The method of claim 3, further comprising:
changing over to a second part diagnosis when an absence of a blockage in the purge line path region arranged upstream of the pressure sensor is detected.

6. The method of claim 5, wherein during the second part diagnosis, a check is carried out for the presence of a tank ventilation valve which is jammed in an open state.

7. The method of claim 6, further comprising:
ending the diagnosis of the purge line path when a presence of a tank ventilation valve which is jammed in an open state is detected.

8. The method of claim 6, further comprising:
when the absence of a tank ventilation valve jammed in the open state is detected, checking whether activation conditions for a third part diagnosis or for a fourth part diagnosis are present.

9. The method of claim 8, further comprising:
changing over to a third part diagnosis when the presence of the activation conditions for the third part diagnosis is detected.

10. The method of claim 9, further comprising:
in the third part diagnosis, checking of the part load purge path arranged downstream of the tank ventilation valve and checking for the presence of a tank ventilation valve jammed in a closed state.

11. The method of claim 10, wherein the diagnosis of the purge line path is ended or, as an alternative, is continued with a fourth part diagnosis when the presence of a defective part load purge path and/or a tank ventilation valve jammed in a closed state is detected.

12. The method of claim 10, wherein when the absence of a defective part load purge path and a tank ventilation valve jammed in a closed state is detected, a changeover is carried out to the fourth part diagnosis as soon as its activation conditions are present.

13. The method of claim 12, further comprising:
changing over to the fourth part diagnosis when the presence of the activation conditions for the fourth part diagnosis is detected.

14. The method of claim 12, wherein the fourth part diagnosis includes:
checking the full load purge path arranged downstream of the tank ventilation valve; and
checking for the presence of a tank ventilation valve jammed in a closed state.

15. The method of claim 1, wherein a pulse width actuation range of the tank ventilation valve is divided into a plurality of ranges, in which pressure signals measured by the pressure sensor are evaluated differently.

16. The method of claim 15, wherein an evaluation of the pressure signals measured by the pressure sensor is not carried out in a first range.

17. The method of claim 15, wherein pressure peaks of the pressure signals measured by the pressure sensor are evaluated in a second range, in order to carry out a diagnosis of the full load purge path and the part load purge path.

18. The method of claim 15, wherein in a third range, the averaged pressure signals measured by the pressure sensor are evaluated for a diagnosis of the purge line path downstream of the tank ventilation valve in the case of a non-actuated tank ventilation valve and in the case of an actuated tank ventilation valve.

19. An apparatus for diagnosing a purge line path of a tank ventilation system of a motor vehicle operated by an internal combustion engine, the apparatus comprising:
a fuel vapor retention filter;
an intake manifold of the motor vehicle;
a tank ventilation valve,
a pressure sensor arranged between the fuel vapor retention filter and the tank ventilation valve;
a purge line path region arranged upstream of the pressure sensor;
a purge line path region arranged downstream of the pressure sensor;
a full load purge path arranged between the tank ventilation valve and the intake manifold;
a part load purge path arranged between the tank ventilation valve and the intake manifold;
a purge line path extending between the fuel vapor retention filter and the intake manifold of the motor vehicle, the purge line path comprising the tank ventilation valve, the pressure sensor, the purge line path region, the purge line path region, the full load purge path, and the part load purge path; and
an engine controller configured to control a method, the method comprising:
executing a plurality of part diagnoses temporally one after another for the diagnosis of the purge line path, the part diagnoses are executed during an active tank ventilation function;
measuring, at pressure sensor arranged between the fuel vapor retention filter and the tank ventilation valve, pressure signals; and
evaluating the measured pressure signals based on the part diagnoses.
